(19) United States
(12) Patent Application Publication
(10) Pub. No.: US 2006/0151906 A1
(43) Pub. Date: Jul. 13, 2006

(54) Method of producing woody formed-body and woody formed-body

(76) Inventor: Takuya Nishimura, Toyota-shi (JP)

Correspondence Address: Douglas J Christensen;Patterson Thuente Skaar & Christensen, 4800 IDS Center, 80 South Eight Street, Minneapolis, MN, 55402-2100, US

(21) Appl. No.: 10/516,175

(22) PCT Filed: May 29, 2003
(86) PCT No.: PCT/JP03/06785

§ 371 Date: Jul. 25, 2005

(30) Foreign Application Priority Data
May 31, 2002 (JP) 2002-159752

(51) Int. Cl. B27N 3/00

(52) U.S. Cl. 264/109; 264/120

(57) ABSTRACT

To provided a woody molded product manufacturing method, including: the step of hardening a surface-side portion of a primary molding body containing a woody material and a thermosetting binder by a smaller compression amount; and the step of hardening a central portion of the primary molding body by a larger compression amount after the step of hardening the surface-side portion. According to this method, by hardening the surface-side portion of the primary molding body by a smaller compression amount, the binding of the woody material is loosely affected with small mutual contact areas, with the molding material being at a lower density. Further, by hardening the central portion of the primary molding body by a larger compression amount, the binding of the woody material is densely affected with large mutual contact areas, with the molding material being at a higher density. Thus, it is possible to obtain a woody molded product having a soft, low-density portion in the surface region and a hard, high-density portion in the central region.

### TECHNICAL FIELD

The present invention relates to a woody molded product produced by hot-press molding, and to a method of manufacturing the same.

### BACKGROUND ART

Boards containing a woody material, such as woody particle, find various uses in buildings, vehicles, etc. as a core material, heat insulating material, sound insulating material, etc. Woody boards, such as particle boards, allow adjustment of various properties, such as strength, bending strength, heat insulating ability, and flexibility through the adjustment of the kind of woody material and binder, clamping conditions, etc. For example, JP 06-297417 A discloses a woody molded product whose surface layer is composed of particles with a specific gravity of less than 0.5 and whose inner layer is composed of particles with a specific gravity of not less than 0.5. This molded product is improved in both bending strength and dimensional stability.

However, the molded product as disclosed in the above-mentioned publication, whose surface and inner layers are formed of different materials, requires preparation of two or more kinds of molding material. Further, the forming process is relatively complicated since the material of one surface layer, the material of the inner layer, and the material of the other surface layer are laminated together in that order for forming a molding material.

### DISCLOSURE OF THE INVENTION

It is an object of the present invention to provide through a simpler process a method of manufacturing a woody molded product which makes it possible to manufacture a woody molded product which is softer on the surface side and harder in the central portion.

As a means for achieving the above object, there is provided a molded product manufacturing method comprising the step of hardening a surface-side portion of a primary molding body, containing a woody material and a thermosetting binder, by a smaller compression amount, and the step of hardening a central portion of the primary molding body by a larger compression amount after the step of hardening the surface-side portion.

According to this method, by hardening the surface-side portion of the primary molding body by a smaller compression amount, the binding of the woody material is loosely affected with small mutual contact areas and with the resulting molding material being at a lower density. Further, by hardening the central portion of the primary molding body by a larger compression amount, the binding of the woody material is densely affected with large mutual contact areas and with the resulting molding material being at a higher density. Thus, by this manufacturing method, it is possible to obtain a woody molded product having a soft, low-density portion at the surface region, and a hard, high-density portion in the central region.

In the present specification, the term compression amount refers to a length obtained by subtracting the thickness of the primary molding body at the time of compression, from the thickness thereof prior to the step of hardening the surface-side portion. This constitutes the compression stroke in the direction of the thickness of the primary molding body.

The compression amount in the step of hardening the central portion is larger than the compression amount in the step of hardening the surface-side portion, so that by performing further compression by a desired amount in the compression state after the step of hardening the surface-side portion, it is possible to obtain a woody molded product according to the present manufacturing method. According to an embodiment, it is possible to make the increment of the compression amount in the step of hardening the central portion, as compared to the compression amount in the step of hardening the surface-side portion, larger than the compression amount in the step of hardening the surface-side portion. In this method, it is possible to form the surface-side portion at a lower density, that is, with a relatively larger number of voids. In addition, it is possible to form the central portion at a higher density, that is, with higher rigidity and higher strength. Such a woody molded product provides a superior heat insulating property and maintains a high strength.

As another means for achieving the above object, there is provided a woody molded product manufacturing method comprising the step of compressing a primary molding body, containing a woody material and a thermosetting binder, to thereby harden the surface-side portion of the primary molding body, and the step of further compressing the primary molding body after the hardening of the surface-side portion to thereby harden a central portion of the primary molding body. After the hardening of the surface-side portion of the primary molding body while in a compressed state, the central portion is hardened through further compression, whereby it is possible to harden the central portion in a state in which it is compressed by a compression amount larger than in the surface-side portion. Thus, it is possible to obtain a woody molded product whose surface-side portion has a lower density and whose central portion has a higher density.

As still another means for achieving the above object, there is provided a woody molded product manufacturing method comprising the step of hardening a surface-side portion of a primary molding body containing a woody material and a thermosetting binder by a predetermined compression amount, and the step of hardening a central portion through further compression, which is not hardened after the hardening of the surface-side portion, making the density of the surface-side portion lower than the density of the central portion.

In these methods, the primary molding body is heated from the surface side in the step of hardening the surface-side portion, and it is possible to maintain the primary molding body at a predetermined thickness for a predetermined period of time. By adjusting the compression amount at this time, it is possible to adjust the density of the surface-side portion of the resultant woody molded product. Further, by adjusting the maintaining time period, it is possible to adjust the thickness of the portion formed at a lower density, that is, the thickness of the surface-side portion. In particular, this method is preferable in obtaining a composition in which a surface-side portion is formed with a relatively uniform density.

Alternatively, in the step of hardening the surface-side portion, it is possible to compress the primary molding body to the compression amount in the step of hardening the central portion over a predetermined period of time while heating the primary molding body from the surface side. In addition, in the step of hardening the central portion, it is possible to compress the primary molding body by a compression amount per unit of time larger than in the step of hardening the surface-side portion. In this method, by adjusting the compression amount per unit of time, that is, the compression rate (press rate), used in the step of hardening the surface-side portion, it is possible to adjust the density and thickness of the surface-side portion when obtaining a molded product. Further, by adjusting the compression amount per unit of time, that is, the compression rate (press rate), used in the step of hardening the central portion, it is possible to adjust the density and thickness of the central portion when obtaining a molded product.

As still another means for achieving the above object, there is provided a woody molded product manufacturing method wherein there is provided the step of heat-compressing a primary molding body, containing a woody material and a thermosetting binder, with upper and lower molds. The heat-compressing step comprising a first lowering step in which the upper mold is lowered and then maintained at a predetermined position for a predetermined period of time to harden the surface-side portion of the primary molded product. And a second lowering step in which the upper mold is further lowered, after the step of hardening the surface-side portion, to thereby harden a central portion of the primary molding body.

As yet another means for achieving the above object, there is provided a woody molded product manufacturing method wherein there is provided the step of heat-compressing a primary molding body, containing a woody material and a thermosetting binder, with upper and lower molds, the heat-compressing step comprising a first lowering step in which the upper mold is lowered to harden the surface-side portion of the primary molded product, and a second lowering step in which the upper mold is further lowered, after the step of hardening the surface-side portion, to thereby harden the central portion of the primary molding body, the upper mold being lowered faster rate in the second lowering step than in the first lowering step.

By these methods, it is possible to obtain a woody molded product having a surface-side portion of a lower density and a central portion of a higher density by utilizing a well-known molding device equipped with upper and lower molds.

As yet another means for achieving the above object, there is provided a woody molded product manufacturing method comprising the step of hardening the surface-side portion of a primary molding body, containing a woody material and a thermosetting binder, at a predetermined compression ratio, and the step of hardening the central portion of the primary molding body at a higher compression ratio than that for the surface-side portion, after the hardening of the surface-side portion. In this method, the surface-side portion is hardened, and then the central portion is hardened at a compression rate higher than that for the surface-side portion, so that the surface-side portion maintains a lower compression ratio even during the step of hardening the central portion. Thus, in the resultant woody molded product, the surface-side portion exhibits a lower density, and the central portion exhibits a higher density.

In any of the above-mentioned methods, it is possible to select kenaf core as the woody material.

Further, it is another object of the present invention to provide a woody molded product that is softer in the surface side portion and harder in the central portion.

As a means for achieving this object, there is provided a woody molded product obtained by one of the above-described woody molded product manufacturing methods, wherein the compression ratio for the surface side portion is not more than 2/9 of the compression ratio for the central portion. In this woody molded product, the surface-side portion exhibits a sufficiently low compression ratio, and is soft, of low density, and superior in a thermal insulating property. In contrast, the central portion exhibits a compression ratio considerably higher than the surface side portion, so that the central portion is hard and of higher density, exhibiting a satisfactory rigidity, strength, etc. Thus, this woody molded product is superior in a surface thermal insulation property and exhibits a high strength.

Further, as another means for achieving the above objects, there is provided a woody molded product which generally consists of a continuous body of a material containing a thermosetting resin and a woody material in the form of particles of a uniform size and specific gravity, wherein the woody molded product exhibits a lower density in the surface side portion than in the inner portion. This woody molded product is a continuous body of a material containing a thermosetting resin and a woody material in the form of particles of a uniform size and specific gravity, so that, even if the density of the surface side portion is lower than that of the inner portion, the material as a whole is continuous and is not easily separated. It is to be noted that in the present specification the term “continuous body” refers to a so-called border-less structure relatively free from sections lacking in mutual entanglement.

In such a woody molded product, it is possible to suitably use a kenaf core as the woody material.

### BRIEF DESCRIPTION OF THE DRAWINGS

FIG. 1 is a perspective view of a woody molded product according to an embodiment of the present invention;

FIG. 2 is a perspective view of a primary molding body used in an embodiment of the woody molded product manufacturing method of the present invention;

FIG. 3 is a plan view illustrating how the primary molding body is compressed to and maintained in a predetermined thickness in an embodiment of the woody molded product manufacturing method of the present invention;

FIG. 4 is a plan view illustrating how the primary molding body is compressed to the thickness of a molded product to be manufactured in an embodiment of the woody molded product manufacturing method of the present invention;

FIG. 5 is a graph showing the density distribution in the thickness direction of a woody molded product (Example 1) obtained by a manufacturing method of the present invention; and

FIG. 6 is a graph showing the density distribution in the thickness direction of a woody molded product (Comparative Example 1) obtained by a conventional manufacturing method.

### BEST MODE FOR CARRYING OUT THE INVENTION

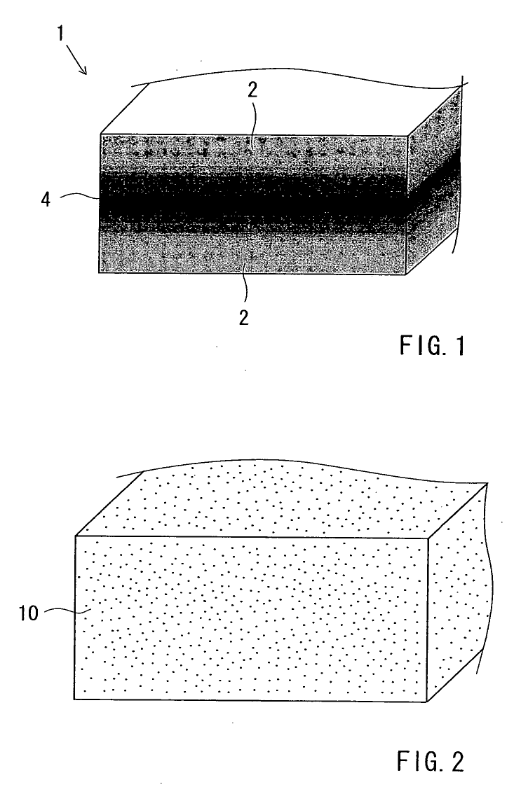

FIG. 1 shows a woody molded product 1 according to an embodiment of the present invention. The woody molded product 1 is formed of a material containing a woody material and a thermosetting resin for binding the woody material.

The woody material is a material containing fibers derived from arbors or herbs and is a particle material in the form of chips, flakes, fibers, powder, granules, or the like. The woody material can be obtained through mechanical crushing, grinding, etc. of dried arbors or herbs. Further, it is also possible to use a woody material that has undergone various chemical treatments. For example, it is possible to use a fibrous material obtained through digestion, or a pulped material. There are no particular limitations regarding the size of the woody material. In the case of the woody molded product 1, used as a tatami-mat core, etc., it is desirable for the material to be in the form of an elongated body or a chip having an average length of approximately 1 to 10 mm. For example, it is desirable for the woody material to be an annual plant that can be cultivated. More specifically, it is possible to use sisal, kenaf, etc. Further, any portion of such plant may be used. For example, when fibers are to be obtained, it is possible to effectively utilize the core (core material) typically disposed of. For example, kenaf core is more preferable.

The thermosetting resin is a resin produced from a thermosetting resin material used as a well-known binder. Examples of such resin include phenol resin, urea resin, melamine-urea resin, and isocyanate resin. The thermosetting resin is dispersed throughout the woody molded product 1, binding the woody material together.

It is possible for the woody molded product 1 to contain various sub-materials, such as preservatives, reinforcing materials, and coloring agents. Further, for example, as a reinforcing material the woody molded product 1 may contain, a fibrous material such as carbon fiber, glass wool, or thermosetting synthetic fiber.

The entire woody molded product 1 consists of the same material, and has on either side, surface-side portions 2 of lower density where the woody material is less dense and a central portion 4 of higher density where the woody material is more densely distributed. The transition is smooth from the surface-side portions 2 to the central portion 4, i.e., from the low-density portions to the high-density portion.

The surface-side portions 2, where the proportion of the woody material component bound together by the thermosetting resin is small, exhibit a lower density. Further, the proportion of the woody material component which has undergone little or no deformation, by crushing or the like by the compression at the time of production or which has only been deformed to a small degree, is large. That is, the compression ratio of the raw material is low in the surface-side portions 2. Thus, in the surface-side portions 2, there are clearances through out the woody material, so that the woody material is disposed to displacement or deformation due to external forces such as pressurization. In this way, the woody material exhibits a high degree of freedom and deformability in the surface-side portions 2. The surface-side portions 2 are formed so as to be highly flexible. Further, the clearances through out the woody material consist of voids, providing a high insulation ability.

In contrast, the central portion 4, in which the woody material is closely bound together by the thermosetting resin, exhibits a higher density. While most of the woody material in the central portion 4 is likely to be crushed and deformed, it is also possible for some of the material to retain a chip form. That is, in the central portion 4, the raw material compression ratio is higher than in the surface-side portions 2. Thus, the central portion 4 is little disposed to displacement or deformation by external forces. In this way, the central portion 4 is formed as a hard portion where the woody material exhibits a small degree of freedom and deformability. As a result, the central portion 4 exhibits high rigidity, imparting a high level of strength to the woody molded product 1.

The woody molded product 1 has a predetermined level of strength and uniform surfaces, and can be suitably used as a member providing a cushioning property (flexibility and elasticity). For example, the woody molded product 1 can be utilized as the core material of a tatami mat, or as an interior decoration material likely to be brought into contact with human bodies. In particular, the woody molded product 1 can be used as a member in which a great vertical force is applied to the surface, as in the case of a tatami-mat core material. Further, the woody molded product 1 can be used as a floor material or a wall material having a cushioning property. Further, since the surface-side portions 2 have many voids and exhibit thermal insulation properties, the woody molded product 1 can be satisfactorily used as a floor material for flooring or the like that is brought into direct contact with human bodies. Further, due to the large number of voids, a sound insulating ability is to be expected, so that the material could be utilized as a floor material mitigating impact sounds such as the sound of footsteps.

Further, the woody molded product 1 as a whole is formed from a continuous body consisting of a material containing a thermosetting resin and a woody material in the form of particles of a uniform size and specific gravity, there being between the surface-side portions 2 and the central portion 4 no distinct borders and uniform dispersement of the woody material particles. Thus, a woody molded product of high separation strength is provided. Further, a molded product is formed having soft surface-side portions and a hard central portion by processing a homogenous kind of molding material. As a result, a reduction is achieved in material cost and operation man-hours.

Next, a woody molded product manufacturing method as applied to the woody molded product 1 of FIG. 1 will be described in detail with reference to FIGS. 2 through 4.

A molding material containing a woody material and a thermosetting binder is prepared. The woody material contained in the molding material is as described above. The thermosetting binder is a thermosetting resin material turned into the above thermosetting resin through heating. For example, when the woody material used consists of finely cut kenaf core material, phenol resin can be used suitably.

While there are no particular limitations regarding the proportion of the thermosetting binder to the woody material, it is desirable for the thermosetting binder to be not less than 5 parts by weight and not more than 20 parts by weight to 100 parts by weight of the woody material. In particular, when strength and flexibility is to be imparted to the surface-side portions at a high enough level to enable the product to be used as the core material of a tatami mat or the like, it is desirable for the thermosetting binder to be not less than 10 parts by weight and not more than 20 parts by weight to 100 parts by weight of the woody material. For example, when the molding material (10) consists of a woody material, in the form of particles derived from kenaf core and having an average length of 5 mm, and a phenol resin material, in the form of powder, it is desirable for their weight ratio to be 9:1.

The woody material and the thermosetting binder are supplied in a state in which they are uniformly mixed with each other. Typically, the thermosetting binder is in the form of powder and is mixed into the woody material, and is finely cut into a predetermined configuration. They undergo agitation or the like until they are brought into a uniform state. Further, it is possible to use a well-known method that allows the thermosetting binder to be uniformly dispersed in the woody material, for example, by causing the binder to adhere to the surface of the woody material by utilizing static electricity.

This molding material is formed into a primary molding body 10 of a predetermined configuration. It is possible to shape the molding material into the primary molding body 10 of a uniform thickness and a uniform configuration by using a well-known forming device. The primary molding body 10 of this embodiment, shown in FIG. 2, has a thickness larger than that of the woody molded product 1 and is in a configuration similar to that of the woody molded product 1.

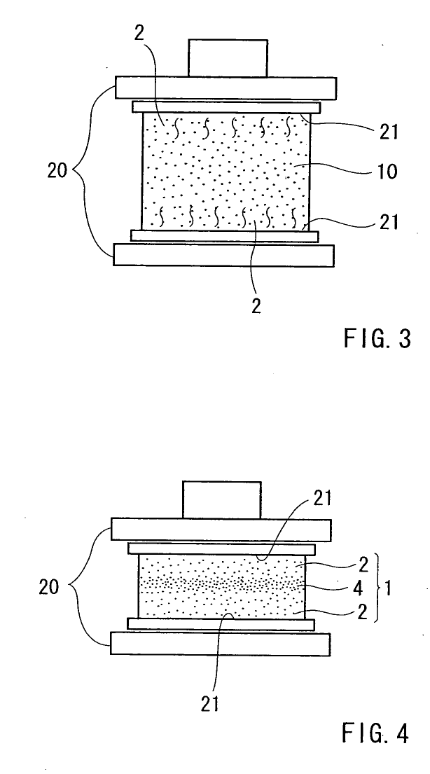

The woody molded product manufacturing method includes a heat-compressing process. The heat-compressing process includes the step of hardening the surface-side portions 2 and the step of hardening the central portion 4. The compression can be performed with a well-known press-molding device. In the embodiment shown in FIG. 3, a pair of press molds 20, whose upper and lower press surfaces 21 are flat, are used. While there are no particular limitations regarding the press molds 20, it is possible, for example, to suitably use a servo control type device that allows easy control of the compression rate, stop positions, and stop time for the press molds 20. When such press molds 20, composed of upper and lower molds, are used, the heat-compressing process may be composed of a first lowering step, in which the upper mold is lowered to a predetermined position in order to harden the surface-side portions 2, and a second lowering step, in which the upper mold is further lowered from the predetermined position in order to harden the central portion 4. That is, the primary molding body is compressed to harden the surface-side portions of the primary molding body. Then the primary molding body thus compressed is further compressed to harden the central portion thereof.

First, the primary molding body 10 is arranged between the press molds 20, and compression is accomplished by a smaller compression amount, that is, by a compression amount smaller than the total compression amount necessary for obtaining the woody molded product 1. More specifically, as shown in FIG. 3, compression is performed to a thickness larger than the thickness to be obtained as the woody molded product 1. In this compressed state, at least the surface-side portions of the primary molding body 10 are heated. There are no particular limitations regarding the heating method. Typically, the primary molding body 10 is heated from the surface sides by using the type of press molds 20 whose press surfaces 21 are heated. Whereby, it is possible to heat the surface-side portions prior to the central portion.

In this embodiment, both press surfaces 21 of the pair of press molds 20 are previously heated by a heater (not shown). The heating temperature is such that the heat will not destroy the woody material and the heat will cure the thermosetting binder. When a primary molding body 10 is used containing phenol resin as the binder, it is desirable to heat the press surfaces 21 to a range of 180° C. to 220° C. (an optimum press temperature generally adopted when phenol resin is used).

By compressing the primary molding body to a predetermined thickness as shown in FIG. 3 and maintaining this state for a predetermined period of time, the portions of the primary molding body to a predetermined depth as measured from the surfaces, i.e., the surface-side portions 2, are heated to a temperature above the curing temperature for the thermosetting binder. The woody material particles in the surface-side portions 2 are held in contact with each other through compression, and are reliably connected together through the curing of the thermosetting binder. Further, the pressure applied to the primary molding body 10 is relatively low, so that it is possible to harden the primary molding body 10 while restraining the crushing of the woody material by pressing. With this process, the hardening step for the surface-side portions is completed.

Next, by accomplishing compression by a compression amount larger than the compression amount used for the step of hardening the surface-side portions 2, that is, by the total compression amount necessary for obtaining the woody molded product 1, the central portion of the primary molding body 10 is hardened. In the step of hardening the central portion, the compression amount is larger than the compression amount in the previous step, compressing the primary molding body 10 to a smaller thickness. As shown in FIG. 4, in this embodiment, the compression is performed to a thickness substantially equal to the total thickness of the woody molded product 1. In this step also, heating is accomplished by the press surfaces 21 of the press molds 20, heating the central portion 4 to the curing temperature for the thermosetting binder via the surface-side portions 2 of the primary molding body 10. During this time, due to the heating or due to a combination of this heating and a vapor generated through the hardening of the woody material and the curing of the thermosetting binder, the woody material is softened. Consequently, the woody material is easily crushed through compression so as to increase the mutual contact areas between the woody material particles.

The thermosetting binder is cured in the state in which the woody material particles of the central portion 4 of the primary molding body 10 are held in close contact with each other, increasing the contact areas. As shown in FIG. 4, in this embodiment, the entire central portion of the primary molding body 10 is cured. Accordingly, the step of hardening the central portion is completed. By hardening the primary molding body 10 as a whole, the woody molded product 1 is obtained.

Here, the compression amount for hardening the central portion 4, after the completion of the step of hardening the surface-side portions 2, i.e., the increment in compression amount, corresponds to the lowering distance of the upper mold after the step of hardening the surface-side portions 2. While there are no particular limitations regarding this amount, when the compression amount is larger than the lowering distance (compressing amount) of the upper mold in the step of hardening the surface-side portions 2, it is possible to make the density of the central portion 4 sufficiently higher as compared to the density of the surface-side portions 2. Conversely, when this increment in compression amount is smaller than the compression amount used in compressing the thickness of the primary molding body 10 during the hardening of the surface-side portions 2, a molded product can be obtained in which there is only a small difference in density between the surface-side portions 2 and the central portion 4.

In other words, the compression ratio, that is, the ratio of the thickness at the time of hardening to the thickness prior to compression (that of the primary molding body 10), {(the thickness of the corresponding material portion in the initial state of the primary molding body 10−the thickness of the corresponding material portion after the hardening)/the thickness of the corresponding material portion in the initial state of the primary molding body 10}, can be freely selected within a range in which the compression ratio is higher for the central portion 4 than for the surface-side portions 2. When the compression ratio of the surface-side portion 2 is lower than the compression ratio of the central portion 4, the surface-side portions 2 have a lower density and many voids, resulting in high heat insulating ability. For example, when the heat-compression is effected such that the compression ratio of the surface-side portions 2 is 2/9 or less of the compression ratio of the central portion 4, it is possible to obtain a woody molded product suitable as a member of which strength and heat insulation ability are required, such as a house member like flooring. In measuring the compression ratios in the woody molded product, the portions where the density in the thickness direction are at maximum values are regarded as borders. The portions on the same side as surfaces with respect to the maximum density portions are the surface-side portions. The portion on the same side as the center with respect to the maximum density portions is the central portion.

In this manufacturing method, by adjusting the compression amounts when the portions of the primary molding body reach the respective hardening temperatures, it is possible to adjust the densities of the respective portions, there by making it possible to adjust the flexibility (hardness) of each portion. That is, when the compression amount is small, the contact areas between the woody material particles are reduced, and the number of clearances, i.e. voids, increases, resulting in a reduction in density. The woody material particles can move toward the voids or undergo deformation due to external forces, resulting in a flexible structure. Further, the heat insulating ability is enhanced. In contrast, when the compression amount is large, the woody material particles are brought into close contact with each other, resulting in an increase in density. Further, the woody material is crushed by pressure and hardened in a deformed state where the material particles are in closer contact with each other. Thereby a hard structure is obtained of a higher density and less voids.

Thus, in the present manufacturing method, it is possible to obtain a woody molded product exhibiting a lower density in the surface-side portions and a higher density in the central portion using a homogenous material. This woody molded product is of a continuous body of woody material, in which separation between the border regions where density change occurrs is restrained in a satisfactory manner.

In the present manufacturing method, by adjusting the compression amount when hardening the surface-side portions 2, it is possible to adjust the flexibility of the surface-side portions 2.

Further, by adjusting the heating time period in the step of hardening the surface-side portions (the holding time at a predetermined compression amount), it is possible to adjust the thickness of the surface-side portions 2. When the heating time period is short, the quantity of heat transmitted is small, so that only the portions nearest to the surfaces of the primary molding body attain the curing temperature for the thermosetting binder, resulting in surface-side portions 2 with a small thickness. Conversely, when the heating time period is long, the quantity of heat transmitted is large, and the curing is accomplished deeper, away from the surfaces, resulting in surface-side portions 2 with large thicknesses.

Still further, by changing the heating temperature, it is possible to achieve approximately the same effect as in the cases where the heating time period is adjusted. For example, by raising the temperature of the press surfaces 21, it is possible to form surface-side portions 2 with larger thicknesses in the same amount of heating time, and by lowering the temperature of the press surfaces 21, it is possible to form surface-side portions 2 with smaller thicknesses in the same amount of heating time.

Thus, in the present manufacturing method, by changing the compression amount and forming time (i.e., changing the quantity of heat transmitted to the primary molding body) when forming the surface-side portions 2, it is possible to change the thickness and density of the surface-side portions 2. Further, by using the same kinds of material in the same amounts, it is possible to produce woody molded products with different thickness ratios and differences in density between the surface-side portions and the central portion without involving a change in weight. For example, by producing a molded product with the same thickness, hard in the central portion 4 and soft at the surfaces, using the same quantity of a primary molding body as in a molded product of a uniform density, it is possible to obtain a molded product having a higher level of rigidity, strength, and heat insulation ability.

As described above, in the woody molded product manufacturing method of the present invention, a balance between the compression amount and the heat transmission state (the binder curing state) is utilized. It is also possible to perform the step of hardening the surface-side portions of the primary molding body over a predetermined period of time by compressing the primary molding body to the thickness of the molded object while heating the primary molding body from the surface sides. For example, pressure is slowly applied to the primary molding body until the compression amount attained is substantially the same amount as that of the woody molded product 1. That is, the primary molding body 10 is compressed by lowering the upper mold at a low press rate. Using this process, the surface-side portions of the primary molding body 10 are hardened while the compression amount varies. In this method in which the primary molding body 10 is hardened while varying the compression amount at a fixed rate, a woody molded product 1 is expected to be obtained that exhibits a gently sloping density gradient in which an increase in density occurs from the surface sides toward the central portion. In the method in which a predetermined compression amount is maintained, as in this embodiment, the upper mold is retained in a fixed position for a predetermined period of time. Layer-like surface-side portions formed with relatively fixed densities are easily obtained, making it possible to achieve a laminate-like density gradient as a whole. Further, at the initial stage, that is, in the step of hardening the surface-side portions, pressure molding is performed at a low compression rate. After compression to a predetermined compression amount, that is, in the step of hardening the central portion, pressure molding is performed at a higher compression rate. Whereby, it is possible to form the surface-side portions and the central portion with a laminate-like density gradient. When a press mold equipped with upper and lower molds is used in this method, the rate at which the upper mold is lowered in the second lowering step, for hardening the central portion, is faster than the rate at which the upper mold is lowered in the first lowering step, for hardening the surface-side portions.

The manufacturing method of the present invention is not restricted to the above-described embodiment.

It is possible for the surface portions and the central portion of the primary molding body to be formed of materials having different compositions. By using materials differing in flexibility, density, etc. for the surface-side portions and the central portion, it is possible to obtain a woody molded product such that each portion of the woody molded product exhibits enhanced properties.

Further, the step of hardening the surface-side portions of the primary molding body (the first lowering step) may be a combination of the methods in which hardening is accomplished while maintaining a predetermined compression amount for a predetermined period of time and the method in which hardening is performed while varying the rate of compression. Further, the rate of compression, that is, the compressing rate, may be fixed or varied continuously or intermittently. Further, when the surface-side portions are to be formed with a more uniform density, the compression time from the start of heating to the attainment of a predetermined compression amount is shortened. When the central portion is to be formed with a more uniform density, the compression time from the smaller compression amount (the compression amount after the completion of the step of the hardening of the surface side portions) to the larger compression amount (the final compression amount) is also shortened.

Further, for this embodiment, density distribution is shown as two stages: the surface-side portions 2 and the central portion 4, but this should not be construed restrictively. It is also possible to adopt a construction exhibiting the density distribution of a plurality of stages. For example, it is also possible to provide a step of hardening the outermost-surface-side portions by a minimum compression amount, a step of hardening the surface-side portions (the portions between the outermost-surface side portions and the central portion) by a larger compression amount, and a step of hardening the central portion by an even larger compression amount.

Further, in the step of hardening the surface-side portions, it is possible to exclusively form one surface-side portion with a lower density by only heating from one surface side. In this case, in the step of hardening the primary molding body by the final compression amount, heating is preferably performed from either side of the primary molding body, whereby it is possible to efficiently heat the entire primary molding body up to a temperature as same as or higher than the curing temperature for the thermosetting binder.

Further, the manufacturing method according to the present invention, in which density adjustment is accomplished in a satisfactory manner when manufacturing a flat woody molded product, is also applicable to the manufacture of a three-dimensional woody molded product of a predetermined configuration.

### EXAMPLES

Density Distribution Measurement

100 parts by weight of chips obtained by crushing kenaf core were mixed with 100 parts by weight of phenol resin. The resultant material was laminated in a plate-like form to a weight of approximately 5 kg/m² and to a thickness of approximately 100 mm, and heat-compressed to obtain a board by a press mold equipped with upper and lower molds. The pressing conditions were as follows:

### Example 1

Temperature of each mold surface: 180° C.

Pressing method: the upper mold was lowered at a lowering rate of 5 mm/s to attain an inter-mold distance of 80 mm, and then kept stationary for approximately five minutes. After that, the upper mold was further lowered at a lowering rate of 5 mm/s to attain an inter-mold distance of 10 mm. Clamping was then performed for ten minutes before opening the molds.

### Comparative Example 1

Temperature of each mold surface: 180° C.

Pressing method: the upper mold was lowered at a lowering rate of 5 mm/s to attain an inter-mold distance of 10 mm. Clamping was then performed for ten minutes before opening the molds.

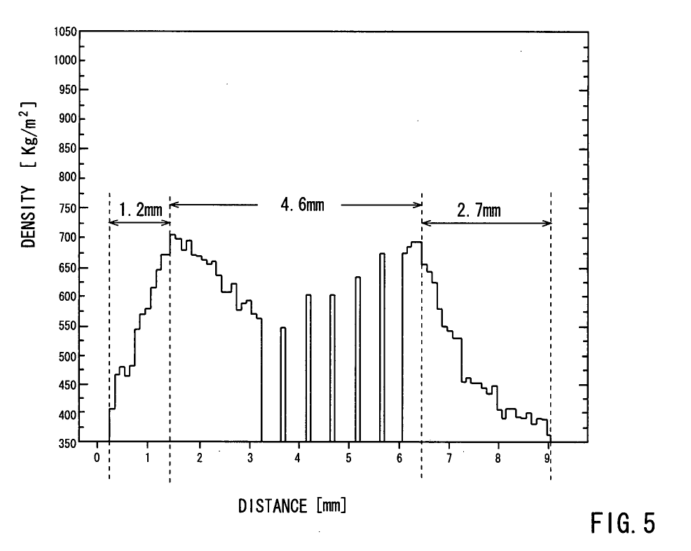

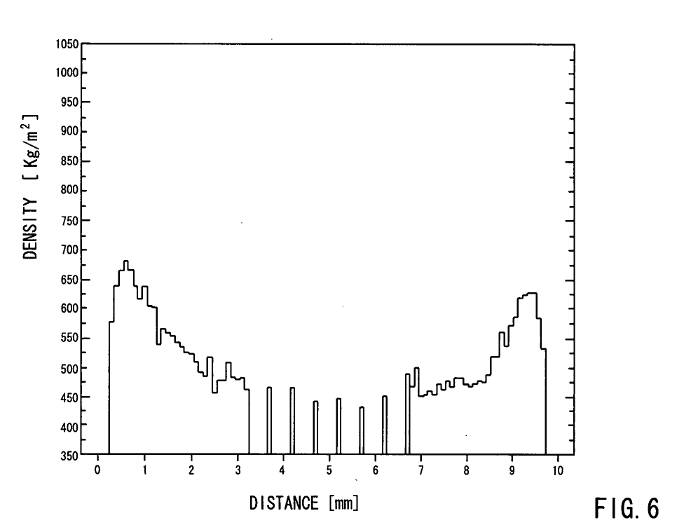

The density gradient in the thickness direction was measured through X-ray analysis of the board of Example 1 and the board of Comparative Example 1. FIG. 5 shows the results obtained in Example 1. FIG. 6 shows the results obtained in Comparative Example 1.

As shown in FIG. 5, in Example 1 the density was lower in the surface-side portions and higher in the central portion. In the surface-side portions the adhesive reaches the curing temperature and is cured when the distance between the upper and lower molds is 80 mm. It is to be assumed that in the subsequent lowering of the upper mold, the Young's modulus in the surface-side portions is higher than in the central portion. As a result, it is to be further assumed that compression was restrained in the surface-side portions, and that the central portion reached the curing temperature for the adhesive while being further compressed by the subsequent lowering of the upper mold, so as to be cured in a higher density state. The average thickness of the board of Example 1 was 8.93 mm. The average density of Example 1 was 564 kg/m³. Further, there were density peaks at the borders between the surface-side portions and the central portion, the density peaks exhibited maximum density.

In contrast, in Comparative Example 1 shown in FIG. 6, it is to be assumed that the lowering of the upper mold proceeds faster than the heating of the surface-side portions to the curing temperature of the adhesive, resulting in the curing being accomplished when the compression is substantially complete. The woody material of the surface-side portions is heated more quickly so as to be softened at an early stage by steam or the like, and is liable to be crushed, so that the surface-side portions exhibit the maximum density. Further, the density is gradually reduced from the surfaces toward the inner side, and the central portion exhibits a lower density. The board of Comparative Example 1 has an average thickness of 9.59 mm and an average density of 499 kg/m³.

Calculation of the Compression Ratio

Regarding the board of Example 1, the compression ratio was obtained with the portions of the board on the surface sides with respect to the maximum-density portion. The borders, being regarded as the surface-side portions. The portion of the board on the center side with respect to the borders is regarded as the central portion. The compression ratio is expressed as follows:
(Compression ratio)={(Thickness prior to compression)−(Thickness after compression) (Thickness prior to compression)}

The thicknesses of the respective portions, sequentially from the left-hand side in FIG. 5, were 1.2 mm, 4.6 mm, and 2.7 mm, and the total thickness was 8.93 mm. From the board press conditions in Example 1, the compression ratio in the surface-side portions is (100 mm−80 mm)/100 mm=0.2. Further, regarding the thickness of the surface-side portions as unchanging after the step of hardening the surface-side portions, the compression ratio in the central portion was calculated with this assumption: (Thickness of the surface-side portions after hardening)−(Sum total of the thicknesses of the surface-side portions of the board)=(Thickness of the central portion at the compression ratio for the surface-side portions). That is, when the compression ratio is 0.2, the central portion is as follows: 80 mm−(1.2 mm+2.7 mm)=76.1 mm, so that, before compression, it is 76.1 mm/(1−0.2)=95.1 mm. Thus, it was (95.1 mm−4.6 mm)/95.1 mm=0.95.

Sensory Test

The board of Example 1, the board of Comparative Example 1, and an ordinary wood flooring material were left to stand in a temperature controlled room at a temperature of 5° C. and a humidity of 30%. The surfaces of the boards were touched by forty subjects for evaluation of felt warmth using the flooring material as a reference. As a result, it became clear that the board of Example 1 and the board of Comparative Example 1 felt warmer than the flooring material, and that the board of Example 1 felt warmer than the board of Comparative Example 1. This result shows that the surface-side portions of the board of Example 1, i.e., the low-density portions, can provide a satisfactory heat insulating ability.

1. A woody molded product manufacturing method, comprising the steps of:
hardening a surface-side portion of a primary molding body containing a woody material and a thermosetting binder by a initial compression amount; and
hardening a central portion of the primary molding body by a larger compression amount after hardening the surface-side portion.

2. A woody molded product manufacturing method according to claim 1, wherein an increment of a compression amount in the step of hardening the central portion is made larger than the compression amount in the step of hardening the surface-side portion.

3. A woody molded product manufacturing method, comprising the steps of:
compressing a primary molding body containing a woody material and a thermosetting binder to thereby harden a surface-side portion of the primary molding body; and
compressing the primary molding body further after the hardening of the surface-side portion so as to harden a central portion of the primary molding body.

4. A woody molded product manufacturing method, comprising the steps of:
hardening a surface-side portion of a primary molding body containing a woody material and a thermosetting binder by a predetermined compression amount; and
hardening a central portion through further compressing, wherein the central portion is defined as a portion that is not hardened during the hardening of the surface side portion,
wherein a density of the surface-side portion is lower than a density of the central portion.

5. A woody molded product manufacturing method according to claim 1, wherein the step of hardening the surface-side portion further comprises: heating the primary molding body from the surface side and maintaining the compression amount at a predetermined thickness for a predetermined period of time.

6. A woody molded product manufacturing method according to claim 1,
wherein, in the step of hardening the surface-side portion, the primary molding body is compressed, to the compression amount in the step of hardening the central portion, over a predetermined period of time while heating the primary molding body from the surface side, and
wherein, in the step of hardening the central portion, the primary molding body is compressed by a larger compression amount per unit time than that in the step of hardening the surface-side portion.

7. A woody molded product manufacturing method, comprising a step of heat-compressing a primary molding body, containing a woody material and a thermosetting binder, with upper and lower molds,
wherein the heat-compressing step comprises:
a first lowering step in which the upper mold is lowered and maintained at a predetermined position for a predetermined period of time in order to harden a surface-side portion of the primary molded product; and
a second lowering step in which the upper mold is further lowered, after the step of hardening the surface-side portion, so as to harden a central portion of the primary molding body.

8. A woody molded product manufacturing method, comprising a step of heat-compressing a primary molding body, containing a woody material and a thermosetting binder, with upper and lower molds,
wherein the heat-compressing step comprises: a first lowering step in which the upper mold is lowered to harden a surface-side portion of the primary molded body; and a second lowering step in which the upper mold is further lowered after the step of hardening the surface-side portion, so as to harden a central portion of the primary molding body,
the upper mold being lowered at a faster rate in the second lowering step than in the first lowering step.

9. A woody molded product manufacturing method, comprising the steps of:
hardening a surface-side portion of a primary molding body containing a woody material and a thermosetting binder at a predetermined compression ratio; and
hardening a central portion of the primary molding body at a compression ratio higher than that for the surface-side portion, after the hardening of the surface-side portion.

10. A woody molded product manufacturing method according to claim 1, wherein kenaf core is used as the woody material.

11. A woody molded product obtained by the woody molded product manufacturing methods according to claim 1, wherein a compression ratio in the surface-side portion is set to 2/9 or lower than a compression ratio in the central portion.

12. A woody molded product, comprising a continuous body of a material containing a thermosetting resin and a woody material in the form of particles of a uniform size and specific gravity,
wherein a density in the surface-side portion is lower than in the inner portion.

13. A woody molded product according to claim 12, wherein a kenaf core is used as the woody material.
